(19) United States
(12) Patent Application Publication
(10) Pub. No.: US 2014/0055254 A1
(43) Pub. Date: Feb. 27, 2014

(54) COLLISION AVOIDANCE SYSTEM FOR VEHICLES

(71) Applicant: Christopher Jack Adams, Bowling Green, KY (US)

(72) Inventor: Christopher Jack Adams, Bowling Green, KY (US)

(21) Appl. No.: 13/987,538

(22) Filed: Aug. 5, 2013

Related U.S. Application Data
(60) Provisional application No. 61/679,366, filed on Aug. 3, 2012.

(51) Int. Cl. G08G 1/16

(52) U.S. Cl. CPC G08G 1/16
USPC 340/435

(57) ABSTRACT

A continuous exterior perimeter monitoring system for collision avoidance by vehicles with exterior objects is provided utilizing microelectronic digital logic circuits and techniques to produce a visual three-digit numerical display, a discrete multi-color display and a multi-level sound warning system, indicating precise and range of distances of exterior objects from vehicles which could collide therewith within pre-selected distances. The system displays many types of vehicle information but prioritizes and acts on collision avoidance data before displaying or acting on non-collision avoidance related information. The system includes computerized system communications and control, embedded web interoperability and network functionality on an SAE J-560 based power line integrated infrastructure.

### REFERENCES TO RELATED APPLICATIONS

This application claims priority to U.S. provisional application Ser. No. 61/679,366 filed on Aug. 3, 2012 which is incorporated by reference in its entirety.

### TECHNICAL FIELD

The present invention relates to the field vehicle collision avoidance systems especially for use on vehicles such as a tractor trailer which have a J-560 based wiring harness for connecting the marker lights on the tractor and trailer to the marker light controls and power within the tractor.

### BACKGROUND OF THE INVENTION

This application incorporates applicant's prior U.S. Pat. No. 5,528,217 which issued on Apr. 17, 1995 from U.S. application Ser. No. 423,042 filed on Apr. 17, 1995 as a continuation in part application of Ser. No. 08/000,487 filed on Jan. 5, 1993 both of which are incorporated herein in their entirety.

Today's confluence of communications in and around vehicles calls for a need to acquire, prioritize and process such communications so that they are utilized to enhance and not interfere with vital simultaneous collision avoidance communications. While there are products which are designed to utilize the SAE J-560 for data culling purposes, there are no instances where the SAE J-560 has been network enabled and web-enabled for collision avoidance purposes, nor have such a broad set of functions been integrated in aggregate for use on the SAE J-560 power line. Due to the ever-increasing need for collision avoidance systems, the ubiquitous proliferation of web-enabled data, and the ever-increasing need to make real time data of all types relevant to other real time data, for the purposes of remote monitoring and control, a need exists for a system which identifies, prioritizes, compiles and prepares collision avoidance data along with non-collision avoidance data. Non-collision avoidance data such as tire pressure and engine related data for display and communication to the driver and other selected entities such as fleet personnel will be given a lower priority when compared with data from a sensor which warns of a possible collision. Such collision avoidance data may also be used to directly apply brakes and actuate o engine controls such as cutting the throttle.

### DESCRIPTION OF THE RELATED ART

U.S. Pat. No. 3,842,397 by Thomas Sindle for an Ultrasonic Distance Detection for Vehicles issued Oct. 15, 1974 and taught an ultrasonic distance detector for vehicles using a plurality of transducers located around the sides of the vehicle and connected to transmitters for sending sonic pulses to distant objects. Each of the transducers is connected to a receiver for detecting sonic echoes from close objects. The output of each receiver is connected to individual indicator lamps and a warning device such as a horn so that if any of the lamps are energized, the driver is warned that one side of the vehicle is in danger of a collision.
U.S. Pat. No. 3,975,708 by Joe F. Lusk for a Vehicle Condition Monitoring System issued on Aug. 17, 1976 teaching display panel or console is mounted in the driving compartment of the vehicle in a position to be observed by the driver and provides status information.
U.S. Pat. No. 3,944,981 by Shigeyuki Akita for an Electrical Wiring System issued on Mar. 16, 1976 teaching an electrical wiring system in which a plurality of automobile electrical devices and instruction switches for operating the electrical devices are interconnected through a single signal line.

Additional patents considered relevant include U.S. Pat. No. 4,015,232 by Thomas Sindle issued on Mar. 29, 1977; U.S. Pat. No. 4,278,962 by Pin-Houn Lin for an Automatic Alarm System for Detecting Obstacles Behind a Backing Vehicle which issued on Jul. 14, 1981; U.S. Pat. No. 4,349,823 by Katsutoshi Tagami issued on Sep. 14, 1982; and U.S. Pat. No. 4,626,849 by John C. Sims issued on Dec. 2, 1986.

A collision avoidance system which works in combination with the instant application is described and patented in applicant's prior U.S. Pat. No. 5,528,217 for COLLISION AVOIDANCE SYSTEM FOR VEHICLES USING DIGITAL LOGIC CIRCUITRY AND RETRO-FITTING TECHNIQUES which issued on Jun. 18, 1196. U.S. Pat. No. 5,528,217 described a means of retrofitting existing vehicles, particularly with respect to large truck tractor-trailer arrangements, including tandem arrangements in order to provide access to the existing electrical wiring system, thereby avoiding the disruption thereof or the need to provide independent electrical wiring systems to effectuate a retro-fit and integration of the present invention with existing electrical wiring and power systems. The electrical wiring system adaptable to the traditional wiring system utilized low power voltage to drive microelectronic digital logic circuitry powered by the vehicle's existing battery system. The microelectronic digital logic circuits used high frequency acoustical waves transmitted and received returned echo signals to develop time-to-distance ranging signals of remote exterior objects that are processed and converted into preselected incremental and exact distances from the vehicle's exterior perimeter to thereby provide continuous monitoring for collision avoidance. The distances were presented as warnings as a three digit numerical display, multi-distance discrete color display and audio warnings so as to avoid collisions with exterior objects in close proximity thereto. The three digit numerical display was generated by use of digital logic circuitry having time-to-distance conversion circuits which in combination with digital binary counter circuits therein, generate the numerical display. The multi-color display of distances to objects and the audio warning alarms were generated by means of digital logic circuitry having at least three voltage comparator circuits for generating the logic signals required to actuate the color display and audio warning alarms.

More particularly, U.S. Pat. No. 5,528,217 described a microelectronics collision avoidance detection and warning system had a plurality of detection devices remotely disposed about a perimeter of a vehicular arrangement for determining a distance between exterior objects and the vehicular arrangement by installing it as a retro-fit to the vehicular arrangement utilizing existing electrical wiring and power system thereof including its chassis. The installed retro-fit provided warnings to an operator compartment of the vehicular arrangement from the detection devices in the form of visual numerical and multicolor displays, and multiple audio sounds and messages. The combination comprised a digital microprocessor having an oscillator circuit with an input connected to the existing electrical wiring and power system of a vehicle for input of electrical power including a plurality of output terminals. The oscillator circuit generated oscillatory frequency output signals for the detection and warning system and electrically grounding through the chassis of the vehicle. A distance ranging circuit was connected at a first input terminal of an output of the oscillator circuit for receiving an oscillatory frequency signal and generating a low frequency high voltage clock output signal and a plurality of high frequency trigger and timing reference output signals. The distance ranging circuit hading a second input terminal for receiving a plurality of analog echo return signals that are converted by the distance ranging circuit into a plurality of digital logic echo output signals. The plurality of high frequency trigger and timing reference output signals and digital logic echo signals were represented as two output signals having a time-to-distance relationship therebetween from which the distances between the vehicle and a plurality of exterior objects were measured. The plurality of detection devices included a dual-function acoustical detection device each operates first as a transmitter and subsequently as a receiver of ultrasonic acoustical sound waves and are disposed at selected perimeter locations of the vehicle. Each of the acoustical detection devices had an input terminal connected to the distance ranging circuit for receiving the low frequency high voltage clock and the high frequency trigger and timing reference output signals therefrom to activate the acoustical detection devices as transmitters of a plurality of incident sound waves and subsequently as receivers of a plurality of returned echo sound waves. The plurality of returned echo sound waves were fed from the acoustical detection devices through the input terminal as analog echo return output signals to the second input terminal of the distance ranging circuit. A second terminal of the acoustical detection devices was connected to the vehicle chassis for electrical grounding. A digital logical processing circuit having a first input terminal was connected to the oscillator circuit for receiving an oscillatory frequency output signal. A second and third input terminal were connected to the distance ranging circuit for receiving the two output signals having a time-to-distance relationship therebetween and converting the two output signals into a plurality of voltage biasing signals and binary coded decimal-to-seven segment digital logic signals that were fed to the existing electrical wiring and power system through a series connected diode device. A voltage comparator processor circuit having a first input terminal connected to the oscillator circuit for receiving an oscillatory frequency output signal and a second and third input terminal were connected to the distance ranging circuit for receiving the two output signals having a time-to-distance relationship therebetween and for converting the two output signals into a plurality of voltage signals that includes three ranges of voltages determined by preset voltage comparator circuits. Each of the three ranges of voltages had a plurality voltage response levels which represent a time-to-distance measurement between the vehicle and an exterior object. The three ranges of voltage signals were fed to an existing wiring and power system through a series connected diode device.

The instant application further defines the prior collision avoidance system by incorporating computerized onboard network or web based inter-connectivity.

### SUMMARY OF THE INVENTION

The instant invention provides a continuous exterior perimeter monitoring system for collision avoidance by vehicles with exterior objects is provided utilizing microelectronic digital logic circuits and techniques to produce a visual three-digit numerical display, a discrete multi-color display and a multi-level sound warning system, indicating precise and range of distances of exterior objects from vehicles which could collide therewith within pre-selected distances. The system displays many types of vehicle information but prioritizes and acts on collision avoidance data before displaying or acting on non-collision avoidance related information. The system includes computerized system communications and control, embedded web interoperability and network functionality on an SAE J-560 based power line integrated infrastructure.

In accordance with the present invention, there is provided a a computerized collision avoidance, detection and warning system comprising, consisting of, or consisting essentially of a plurality of detection devices, a centrally located display unit, left and right mirrors containing collision avoidance displays, and a computer. The plurality of detection devices remotely disposed about a perimeter of a vehicular arrangement is for determining a distance between exterior objects and the vehicular arrangement by installing retro-fittable marker light units in place of currently installed marker lights to the vehicular arrangement utilizing existing electrical wiring and power system. The detection devices include an optically transparent antenna, a proximity detector capable of detecting objects within a selected distance of the detector, and circuitry enabling IEEE 802.1 communications with external devices. The central display unit within an operator's cab in the vehicular arrangement displays collision avoidance information and non-collision avoidance information. The left and right side mirrors exterior to the operator's cab each contain a display area including an image of the vehicular arrangement surrounded by LED's corresponding to each one of the plurality of detection devices. The LED's include multicolor illumination wherein each color corresponds to a selected distance between a corresponding one of the detection devices and an object external to the vehicular arrangement. The computer is capable of processing information from the plurality of detection devices and provides warning messages to the operator compartment of the vehicular arrangement from the detection devices in the form of visual multicolor displays and multiple audio warnings. The computer communicates with the plurality of detection devices: the central display, the displays on the left and right side mirrors over an existing J560 wiring harness on the vehicular arrangement.

In the following description, numerous specific details and options of the present invention are set forth in order to provide a more thorough understanding of the invention. It will be appreciated, however, by one skilled in the art that the present invention may be practiced without such specific details or optional components and that such descriptions are merely for convenience and as such solely selected for the purpose of illustrating the invention. Reference to the drawings and photographs showing embodiments of the present invention are made to describe the invention and do not limit the scope of the disclosure herein.

The present invention includes a protocol which extends the use of the SAE J-560 power line beyond being a collision avoidance communications bridge to being more of a communications network which can support other applications, functionality, and forms of data. The application prioritizes communications data for network handling relative to a specific top priority, that is, collision avoidance data. This protocol, called “DC RATT”, is designed to run on a network which is wired to a standard 7-pin electrical connector-based network infrastructure or SAE J-560 connector-based network infrastructure, typically found on articulated vehicles, tractor-trailers, military vehicles, or farm equipment. The protocol also serves as a much-needed platform for holding data within a space for translation and processing subsequent to collecting other J-560network data, and transfer of the data or applications for match-up and integration to and with other different but relevant communications and data, such that the data can be related to the collision avoidance activity, relative to the J-560 network.

The SAE J-560 electrical connector is a global standard in articulated vehicle design worldwide. Christopher Jack Adams pioneered the novel concept of utilizing this ubiquitous power line design also as a communications bridge, specifically to host, receive, process, and send collision avoidance data and interpret algorithms for actuation and response for the safety and preservation of operators, vehicles, the public and payload. [U.S. Pat. No. 5,528,217 Collision Avoidance System for Vehicles Using Digital Logic Circuitry and Retro-Fitting Techniques, herein incorporated by reference.]

Remote real time control, a long sought after standard in industrial control, was pioneered as a browser-based embedded web server application by N.A.S.A. Glenn Research Center, in 1999. Tempest is a Web server created to provide Internet/Intranet connectivity to real-time, embedded applications. Tempest was the first HTTP server of its kind for real-time embedded systems. An embedded Web server, like Tempest, is the key element in Embedded Web Technology (EWT). EWT is a unique marriage of World Wide Web technology [typically browser-based] and Embedded Systems technology. Applied Research Designs, Inc., acquired the rights to this technology and the associated concepts therein, in 1999, and have since developed advancements which are proprietary and have significantly advanced the state of this intellectual property.

The DC Ratt protocol is an evolution of Tempest, that enables the SAE J-560 power line to have web-based interoperability and limited broadband-style functionality as a communications network. The use of the J-560 power line as more than a communications bridge, more like a J-560 based network, also forms a major basis for technology used in the present invention.

It has been found that increasing of throughput and data transfer speeds, while reducing data errors can be achieved through the novel usage of both asynchronous transfer mode and synchronous transfer of data, depending on data type, which is also conducive to communication schemes for maximizing performance [throughput, speed, multitasking of communications] from networks which aren't specified to perform very highly, whether the communications infrastructure be the comparatively narrow throughput of the J-560 serial bus or a high throughput community-based 802.11-based network. This state of the art embedded web technology forms a key component to the method for handling data on SAE J-560 based networks and as a part of the DC Rat software communications protocol. Tempest has since been ported to Java and generic [UN-enhanced] versions are available today.

The challenge is to marry these two novel concepts, to bring embedded web applicability to J-560 based networks. This new system will host applications on J-560-based power lines which equivocate to embedded web operable network support including solving the challenges to effectively prioritize these applications and the data therein while also hosting collision avoidance data. To solve this challenge, the present invention gives embedded web interoperability to J560-based power line communications networks such that real time controls and communications can be hosted, integrated, processed, sent and received within the network vis-a-vis operator/controller, or from network to network, vis-a-vis standard web-based browser interfaces.

It is therefore an object of this invention to provide a vehicle collision avoidance system which includes the collision avoidance system described and patented in applicant's U.S. Pat. No. 5,528,217 networked with a computer which is running system control software including applicant's DC Ratt protocol for prioritizing and acting on collision and non-collision avoidance data. The collision avoidance system is further enhanced by adding user displays in the lower portion of the left and right mirror on the tractor doors and using optically transparent postage stamp antennae incorporated onto the lenses of sophisticated marker light units located around the periphery of the tractor and trailer.

It is also an object of this invention to provide a vehicle collision avoidance system which uses a standardized wiring harness connector used to connect hard wiring on a self-propelled machine to hard wiring on an attached implement for the purpose of controlling lights or other electrically powered equipment, implements, applications, communications on or to the attached machine. The connector should meet the requirements of CSA-M663-92, “Seven-Pin Electrical Connector and Cable for Agricultural Towing/Towed Equipment” or SAE Standard J560, “Seven-Conductor Electrical Connector for Truck-Trailer Jumper Cable”, and should be mounted on the towing vehicle according to ASAE Standard S279.9, Lighting and Marking of Agricultural Field Equipment on Highways.

It is another object of this invention to provide a vehicle collision avoidance system which uses a standard SAE J-560-based power line as a communications bridge, particularly for collision avoidance, whereby the marker light of the truck-trailer is used as a communications interface for collision avoidance data.

It is also an object of this invention to provide a vehicle collision avoidance system which uses a standard SAE J-560-based power line communications bridge as a broadband-communications style network for handling non-collision avoidance data simultaneously with collision avoidance data on the same network, yet allowing for appropriate prioritization of collision avoidance data relative to non-collision avoidance data.

It is also an object of this invention to provide a vehicle collision avoidance system which uses a prioritization ladder scheme on J560 networks, as a part of a protocol known as the DC Ratt protocol, which identifies and transfers collision avoidance data real time using synchronous real time transfer mode while transferring non-collision avoidance related data asynchronously, in serialized events.

It is another object of this invention to provide a vehicle collision avoidance system which uses advancements in a web server technology known as Tempest which is an embedded web server technology, originally developed by N.A.S.A. Glenn Research Center and subsequently licensed in 1999 for further development by Applied Research Designs, Inc.

It is also an object of this invention to provide a vehicle collision avoidance system which utilizes advancements in real time monitoring and control relative to data, communications and applications running on J-560 networks, or as a part of the DC Ratt protocol.

Still another object of this invention is to provide a vehicle collision avoidance system which employs advancements in the field of remote environmental monitoring systems (REMS) technology, originally developed in 2000, by Applied Research Designs, Inc., in conjunction with Honeywell Federal Manufacturing and Technologies, as applied to real time monitoring and control relative to data, communications and applications running on J-560 networks, or as a part of the DC Ratt protocol.

It is another object of this invention to provide a vehicle collision avoidance system which uses optically transparent antenna technology developed by Applied Research Designs, Inc., in 2002, in conjunction with N.A.S.A. Glenn Research Center. (Attached hereto is the “Confidential Development of a Prototype Transparent Antenna, Final Report, Richard Q. Lee and Rainee N. Simons, NASA Glenn Research Center, Cleveland, Ohio, 44135; James Rattleff, AR Designs, Chicago, Ill. 60611, October, 2003” which is herein incorporated by reference.) This invention involves the use of advanced optically transparent antenna technologies and protocols as they may be applied to J-560 networks, or as a part of the DC Rat protocol communications schemes.

The present invention provides a method comprising the steps of:

utilizing the SAE J-560 as a communications network,

utilizing the SAE J-560 as an integrator of all relevant network communications,

employing API's (applied programming interfaces) specifically designed for use on an SAE J-560 based network,

employing a communications protocol for use on an SAE J-560 based network,

employing a synchronous and an asynchronous set of transferring modes, which constitute a prioritization ladder, based on the identification of and classification of data running on an SAE J-560 based network,

employing a protocol composed of API's designed to handle collision avoidance data and non-collision avoidance data simultaneously on an SAE J-560 based network,

employing a communications protocol which is the designated host for receiving, translating, processing, integrating, actuating, qualifying and transferring data within an SAE J-560 based network,

utilizing an enhanced form of the Tempest real time embedded web server technology as a part of a protocol for remote real time monitoring and control of systems and data on an SAE J-560 based network,

making an SAE J-560 based network with interoperability with browser-based communications and other real time or J-560 network applicable communications and API's,

using an SAE J-560 based network communications scheme that features REMS (remote environmental monitoring system) functionality, and

using a network communications scheme which can process, prepare and port data equally well to any of the following: web browser, broadband communications nodes, smart antennas, including optically transparent antenna interfaces, smart displays, or any central processor-GUI (graphical user interface) platforms connected to an SAE J-560 based network.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a top view of a tractor trailer combination showing the J 560 wiring harness, marker light proximity sensors, computer, and side view mirrors.

FIG. 2 is a side view of the tractor trailer combination of FIG. 1.

FIG. 3 is a side view of a marker light with proximity sensor.

FIG. 4 is a front view of a marker light with proximity sensor and transparent antenna.

FIG. 5 is a top view of a tractor trailer combination showing the angular areas of coverage of the marker light proximity sensors.

FIG. 6 is a front view of a left side mirror showing the display window with LED's indicating objects in close proximity to the tractor trailer in a given area around the tractor trailer.

FIG. 7 is a front view of a right side mirror showing the display window with LED's indicating objects in close proximity to the tractor trailer in a given area around the tractor trailer.

### DESCRIPTION OF THE PREFERRED EMBODIMENTS

In accordance with the present invention, there is provided a collision avoidance system for tractor trailer combinations which includes multiple user interfaces for the display of collision avoidance information and non-collision avoidance information, vehicle peripheral sensors contained in marker lights, at least one computer containing collision information protocol software, a central communications wiring network which is the standard J-560 wiring harness which is already present on all known commercial tractor trailer combinations.

A vehicle which features the SAE J-560 power line typically has an array of on-board systems, controls or implements, which are power line connected. Today there are a plethora of reasons to access these on-board systems individually or as a grouping for monitoring and control, locally and remotely. However, the hardware for interfacing with one of these systems often lacks integration with other separate on-board systems and communications. There lacks a means to interrelate and integrate relevant data with other systems and their data, chiefly, collision avoidance data. Furthermore, many communications protocols employed to assess systems health or perform controls, are proprietary and not web-operable. All these systems add additional hardware, power demands, bandwidth demands and wiring and can create enough network interference to fatally degrade network performance. The technology present herein is the only retro-fittable means to ‘touch’ each critical system if the system is already wired to the J-560 power line, and if running D.C. Ratt Protocol, as a network. This technology enables cross platform communications with other systems, GUI's, microprocessors and communication centers connected to the J-560. Collision avoidance data must be handled at a higher standard (no latency or errors, increased throughput) with tiered prioritization of data, which requires a network approach with collision avoidance network data.

Below are four technologies which are integrated in the present invention in order to convert the J-560 wiring harness into a J-560 network capable of handling communications protocols and multitasking of data:

1. Multiplexing

2. Optical Transparent Antenna and Protocols

3. Embedded Web Technology

4. REMS (Remote Environmental Monitoring System)

1. Multiplexing: The Standard SAE J-560 Connector Combined with Analog & Digital Multiplexing and Protocols

Signal multiplexing includes the combining of separate fragments of data in the form of digital signals on one channel and sending the data to the destination user interface where the fragments are decoded and recombined as the originally issued data. Multiplexing allows for several different digital data sources to be processed and sent simultaneously to each of their unique and proper destinations. Signals in this form can be processed more discretely, benefitting from less interference and lower jitter.

Multiplexing is the method we employed for digitizing the SAE J-560 connector power line to enable the simultaneous transmission of data, text, voice, video, audio and other content across the SAE J-560 power line. Software development kits (black boxes or virtual black boxes) are installed on each end of the J-560 connector to enhance data throughput and signal processing. Through the use of end to end digital connectivity, hardware and software can seamlessly operate multiple digital channels through the SAE J-560 power line. This form of end-to-end digital switching converts analog signals into digital for multiplexing. This multiplexing process, in conjunction with the use of novel protocols, transforms the J-560 into a distributed high speed network, with high reliability, high-speed file transfer rates and no or low errors. The process enables a method of designing signal processing filtration across the J-560 connector-based network. The usage of software protocols ported to enhanced input and output functions at high speed data rates are the means employed to stretch the limits of the SAE J-560 power line, and prepare the network to run advanced APIs and applications, to interface with advanced antenna hardware and software, and to interface with other advanced broadband networks.

2. The Optically Transparent Antenna and Protocols

The Optically Transparent Antenna can simultaneously process different frequency range communications and can apply [provided specific hardware, engineering modifications and protocol] to interface a J-560 network communication with other networks outside the wired limits. The optical transparent antenna technology connects multiple segments of the tractor and trailer (i.e. marker lights), reduce data bottlenecks on the J-560 connector, and connect different browsers and different network architectures, devices, and transmit data between the tractor and trailer over the J-560 connector. The technology can also be utilized to aid in the synthesis of communications off and on the J-560 network, for instance with nearby fleet vehicles. The Optically Transparent Antenna, associated electronics and protocols can be, as a system, a ubiquitous component of a mobile infrastructure. The Optically Transparent Antenna has a great facility for processing different frequency range-based communications simultaneously and further includes a stealth design [optically transparent] and the potential for low-cost manufacture [thin film]. The Optically Transparent Antenna is further described in Optical Transparent Microstrip Patch and Slot Antennas, U.S. Pat. No. 5,872,542, herein incorporated by reference.

There are four tiers to the functionality of the transparent antennas and their sensing and communicating capabilities:

1. For support of back-up and redundancy purposes for the primary wire line J-560 network communications;

2. For object detection and information gathering purposes to feed relevant data into the D.C. Rat protocol;

3. For qualitative object recognition, for example, to determine whether object in the perimeter of the truck is fixed or moving; or whether the object is a car, human, animal or structural, hidden behind a structure, friend or foe;

4. For actions tied to qualitative object recognition, such as, to actuate collision avoidance actions or other relevant communications for specifically recognized objects. For example, if the object is human, to record video and send audible warning; if object is a car or another truck, to communicate machine to machine protocols to perform collision avoidance and safety maneuvers or otherwise service support of data synchronization and transfer or for performing network data transmissions. Moreover, if the object is a foe, for actuation of attack or defense features or procedures, if the object is friendly, to initiate allied protection or security schemes or network annexation protocols.

Citation: “Confidential Development of a Prototype Transparent Antenna, Final Report, Richard Q. Lee and Rainee N. Simons, NASA Glenn Research Center, Cleveland, Ohio, 44135; James Rattleff, AR Designs, Chicago, Ill. 60611, October, 2003” previously incorporated by reference.

3. Embedded Web Technology, Tempest

Tempest is a server created to provide Internet/Intranet connectivity to real-time, embedded applications. The Tempest was the first HTTP server of its kind for real-time embedded systems. Tempest has been ported to the Java Version offered on the website https://sr.grc.nasa.gov/public/project/71/, which is herein incorporated by reference. An embedded Web server, like Tempest, is the key element in Embedded Web Technology (EWT). EWT is a unique marriage of World Wide Web technology and Embedded Systems technology. In addition to many standard Web functions, Tempest has the following features: Custom dynamic HTML tags for snapshot views of the real-time operating system and application events, customized Web pages by user Command line options, ASCII configuration files, logging, debugging, and ID/pw security. Java version of Tempest runs on a wide variety of operating systems, desktop and embedded. This technology was developed originally at NASA Glenn Research Center (then, NASA Lewis) during the mid 1990s and won “Software of the Year Award” in 1998. The original invention was optimized for remotely running a wind tunnel experiment, in addition to applications in space-based remote experiments in micro-gravity. It addressed the need to host operators collaborating remotely while using different computing platforms, often speaking different languages by converting data to a web-compatible format, thereby becoming a common platform to host and process networked, remote real-time communications. The functionality standard [then, HTML, now XML] required that the software be browser operable [then, MOSIAC, NETSCAPE, IE; now, FIREFOX, IE, CHROME, SAFANIi, etc.], be able to run APIs [then, Java Applets or executable embedded web programs] with user customizable GUIs. Since that time, we adapted the technology for applicability to the SAE J-560 power line-based infrastructure, particularly for integration to an advanced hybrid antenna such as the optical transparent antenna technologies we have enhanced.

4. REMS

AR Designs co-developed a Remote Environmental Monitoring System (REMS) under CRADA with the U.S. Dept. of Energy and Honeywell Federal Manufacturing & Technologies: Citation: “Honeywell: Remote Environmental Monitoring System”, CRADA Federal Manufacturing & Technologies, R. D. Hensley. KCP-613-6311, Published March, 2000: Final Report/Project Accomplishments Summary CRADA Number 98KCP 1065, prepared under Contact Number DE-ACO4-76-DP00613 for the Dept. of Energy” herein incorporated by reference.

AR Designs' systems architecture design expertise was mated with Honeywell's radio frequency [RF] expertise in order to develop a wireless communications system, including communications, command and control software, for remotely monitoring the environmental state of a process or facility. In 2000, network communications was enabled for real time embedded systems to access remote workstation services, such as GUI, I/O, events, video, audio, etc. The enhanced and modified to enable network communications for real time embedded systems, powered by the SAE J-560. Adding embedded web-compatibility and interoperability [see below] allows for an updated version to work with contemporary standards.

The black box technology supports the SAE Dedicated Short Range Communications (DSRC), The SAE J2735 message sets over DSRC networks. The DC Rat protocol and black box technology supports several DSRC standards; The IEEE 1609 standard, The SAE J2735 DSRC. In addition the DC Ratt protocol and black box technology supports the IEEE 802.16 standard, the IEEE 802.11a, b, g standards (2.4-5.8 GHz), also this includes data exchange in the licensed ITS band of the IEEE 802.11p (5.85-5.925 GHz) frequency range.

Integration of the DC Ratt. SAE J560, and the SAE J1939 Protocols

The following is an overview of the integration process to join the SAE J560 and the SAE J1939 Controller Area Network (CAN) protocol with the DC Rat protocol and optical transparent antennas.

The DC Rat protocol and the CAN protocol are tightly integrated into a development platform to interface with the wireless bridge and wireless transceiver modules to be configured with address information pertaining to marker light positions. Fully integrated marker lights with the transceiver and optical transparent antennas would serve as the replacement of existing marker lights by simply plugging the new marker lights into the truck's existing wiring harness and the J 1939 interface.

Utilizing the wireless bridge in the tractor and trailer enables a two way, high-speed communications link over the J560 connection and wiring. The typical speed of the J560 connection is 250 kbps. Speeds well over 2 Mbps over the J560 connection and wiring have been used successfully. Thus the J560 network configuration enables more data bandwidth to the tractor and trailer allowing other applications to be added, like real-time video and high-speed Internet access.

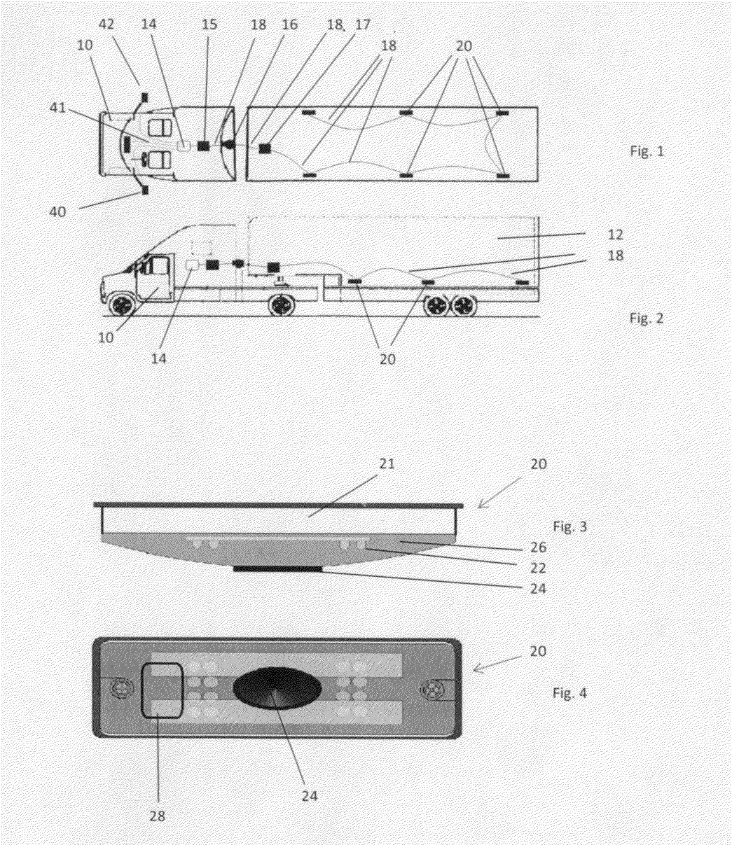

FIGS. 1 and 2 show a top view and a front view of a tractor 10 and an attached trailer 12 for over the road transport. The tractor 10 includes a computer 14 which is connected to a black box 15 containing electronics necessary to interface the computer 14 with the data stream present on the J-560 cable line 18 connecting all of the marker lights 20 to the system. A J-560 connection 16 includes a male connector and female connector to allow the tractor electrical harness to be detached from the trailer electrical harness. Black box 15 also includes circuitry to support system programming and development as desired. Going into the trailer from the J560 connection 16, the J560 cable 18 connects to the black box 17 and then daisy chains on to the marker lights 20. Black box 17 also includes circuitry to support system programming and development as desired.

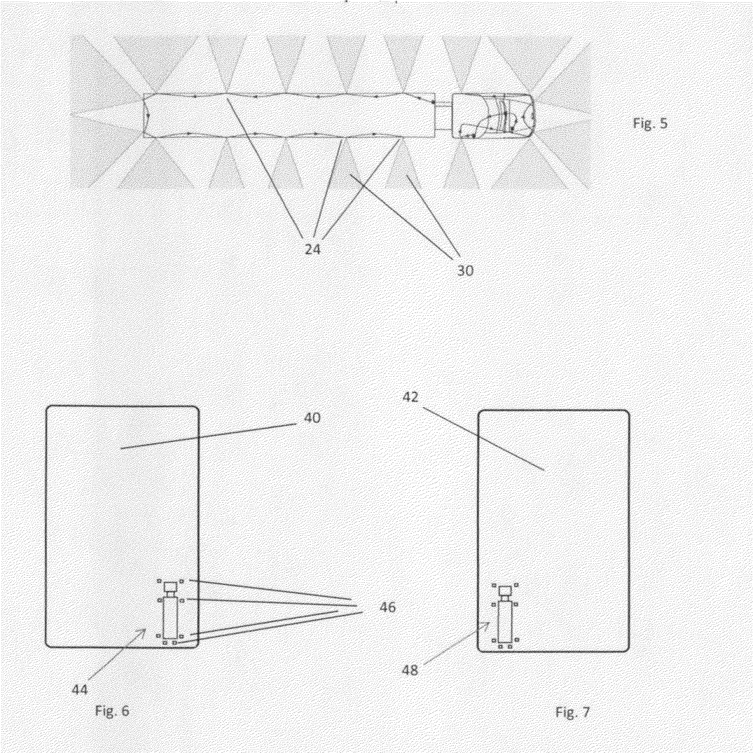

As seen in FIGS. 3 and 4, the marker lights 20 include more than just light bulbs or LED's 22. On the front center of marker light 20 is a proximity sensor 24 connected to a processor 21 within the marker light 20. An optically transparent antenna 28 is affixed to marker light lense 26. The antenna 28 is also electrically connected to the processor 21. The processor 21 is programmed to process the signal from the proximity sensor to give four different levels of proximity of an object . . . no object detected; object detected within 15 feet; object detected within 10 feet; or object detected within 5 feet. FIG. 5 shows a tractor trailer combination and the sweep angles 30 monitored by a plurality of marker light proximity sensors, 24. The location of detected objects and other information is passed over the J560 network back to the computer 14 for display to the vehicle operator or for possible actions such as operating the brakes and decelerating the vehicle engine. The processor 21 is further capable of wireless communication over the antenna with other devices which use 802.11 or 801.16 standards.

FIGS. 6 and 7 show the left side mirror 40 and right side mirror 42, respectively. The left mirror has a display window 44 at the lower right portion of the mirror and the right mirror 42 has a display window 48 at the lower left portion of the mirror. The displays are directly driven by the computer 14 through cables 41. The display includes a diagram of the tractor trailer along with LED's 46 around the periphery of the image of the tractor trailer. Each one of these LED's corresponds to one of the marker light proximity sensors 20 located at the corresponding position on the tractor or trailer. and each one of the LED's has four possible states; off, green, yellow or red. When the LED is off, no object is detected by the proximity sensor. When the LED is green, there is an object detected between 10 and 15 feet from the sensor. When the LED is yellow, there is an object detected between 5 and 10 feet from the sensor. When the LED is red, there is an object detected between 0 and 5 feet from the sensor. It is anticipated that the green, yellow and red LED's could correspond to distances other than these, such as 5, 15 and 30 feet as determined by the circuitry within the marker light 20.

FIG. 1 also shows a central operator display 11 which shows collision avoidance information along with non-collision avoidance information such as engine information, vehicle speed, and so on.

It is further anticipated that the black boxes 15 and 17 include wireless routers which enable the computer 14 to communicate wirelessly with exterior devices such as the processors 21 in the marker lights 20 (perhaps as backup to the J560 network), computers in other trailer devices such as refrigeration units, other vehicles such as fleet vehicles, internet connectivity, and so forth. In other works, wireless communication is enabled between the tractor, trailer, marker lights, and devices external to the tractor or the trailer. It is anticipated that such wireless communication is based on IEEE 802.1 standards.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A computerized collision avoidance, detection and warning system comprising:
a plurality of detection devices remotely disposed about a perimeter of a vehicular arrangement for determining a distance between exterior objects and said vehicular arrangement by installing retro-fittable marker light units in place of currently installed marker lights, to the vehicular arrangement utilizing existing electrical wiring and power system, said detection devices including an optically transparent antenna, a proximity detector capable of detecting objects within a selected distance of said detector, and circuitry enabling IEEE 802.1 communications with external devices;
a central display unit within an operator's cab in said vehicular arrangement for displaying collision avoidance information and non-collision avoidance information;
a left side mirror and an a right side mirror exterior to said operator's cab each of said mirrors containing a display area including an image of said vehicular arrangement surrounded by LED's corresponding to each one of said plurality of detection devices, said LED's including multicolor illumination wherein each color corresponds to a selected distance between a corresponding one of said detection devices and an object external to said vehicular arrangement;
a computer capable of processing information from said plurality of detection devices and providing warning messages to an operator compartment of said vehicular arrangement from said detection devices in the form of visual multicolor displays, and multiple audio warnings; and
said computer communicating with said plurality of detection devices, said central display, said displays on said left and right side mirrors over an existing J560 wiring harness on said vehicular arrangement.

2. The computerized collision avoidance, detection and warning system defined in claim 1 wherein said computer receives non-collision information from devices such as engine monitoring devices, vehicle speed monitoring devices, in addition to collision avoidance information from said plurality of detection devices and said computer contains software including communications protocol for specifically prioritizing incoming information so that collision avoidance information from said plurality of detection devices is given top priority over said non-collision information.

3. The computerized collision avoidance, detection and warning system defined in claim 1 including at least one wireless router which enables IEEE 802.1 communications with external devices such as said plurality of detection devices remotely disposed about a perimeter of said vehicular arrangement, engine monitors, vehicle monitors, web enabled devices and external computers or computerized equipment.
